(19) United States
(12) Patent Application Publication
(10) Pub. No.: US 2018/0012297 A1
(43) Pub. Date: Jan. 11, 2018

(54) SYSTEMIC RISK MANAGEMENT SYSTEM, SYSTEMIC RISK MANAGEMENT METHOD, AND STORAGE MEDIUM STORING SYSTEMIC RISK MANAGEMENT PROGRAM

(71) Applicant: NEC Corporation, Minato-ku, Tokyo (JP)

(72) Inventor: Yoshiharu MAENO, Tokyo (JP)

(73) Assignee: NEC Corporation, Minato-ku, Tokyo (JP)

(21) Appl. No.: 15/550,081

(22) PCT Filed: Feb. 17, 2016
(86) PCT No.: PCT/JP2016/000828

§ 371 Date: Aug. 10, 2017

(30) Foreign Application Priority Data
Feb. 24, 2015 (JP) 2015-033997

(51) Int. Cl. G06Q 40/02; G06Q 40/06

(52) U.S. Cl. CPC G06Q 40/025; G06Q 40/06

(57) ABSTRACT

This systemic risk management system comprises: a sampling means which, given a set of interbank loans, i.e., loans of funds from any of multiple banks to any borrower included in the aforementioned multiple banks, generates a sample which represents the aforementioned set modified by means of a reconnection in which the aforementioned borrower of the interbank loan selected from the set is replaced with a selected bank; an important transaction designation means which selects multiple of the aforementioned generated samples on the basis of the scale, derived on the basis of the set represented by the sample, of a bankruptcy of the multiple banks resulting from the effects of the collapse of prescribed investments of at least one of the multiple banks, and which designates an important interbank loan on the basis of the interbank loans included in the aforementioned selected multiple samples in which reconnections have been made; and an important bank designating means which designates an important bank on the basis of the designated important interbank loan.

### TECHNICAL FIELD

The present invention relates to a technology that manages a systemic risk.

### BACKGROUND ART

A risk that the dysfunction of an individual financial institution or the like spreads to another financial institution or the entire financial system is commonly called a systemic risk.

In the following description including example embodiments, the systemic risk refers to a risk of collapse of the entire financial network, i.e., a risk of occurrence of very serious chain-reaction bankruptcies, rather than a risk of the bankruptcy of an individual bank. The financial network refers to, for example, a graph-like structure representing an interbank transaction relationship including an interbank loan of funds, as described later.

Examples of technologies relating to systemic risk management are described in NPL 1 to NPL 3.

In the technologies, the financial network is described using a mathematical model representing the bankruptcy of a bank caused by the propagation of losses across banks and the accumulation of the losses. Examples of input information input into the financial network include the financial affairs, investment and financing, and interbank loans of banks included in the financial network. The fundamental function of the systemic risk management is to estimate the scale of the number of chain-reaction bankruptcies from the financial network, thereby setting the estimated scale of the number of the chain-reaction bankruptcies as output information. The systemic risk is determined based on the scale of the number of the chain-reaction bankruptcies. The more the scale of the number of the chain-reaction bankruptcies is, the higher the systemic risk is. In particular, when the scale of the number of the chain-reaction bankruptcies is close to the number of the banks included in the financial network, the systemic risk can be considered to be so high that the entire financial network can collapse.

NPL 1 discloses the most fundamental mathematical model for estimating the scale of the number of chain-reaction bankruptcies.

NPL 2 discloses an advanced mathematical model taking, into consideration, the problems of the investment, financing, and asset liquidity of banks.

NPL 3 discloses a further advanced mathematical model taking, into consideration, the problem of a collective behavior seen in the investment and financing of banks.

An example of the models that are based on the technologies of NPL 1 to NPL 3 and estimate the scale of the number of chain-reaction bankruptcies is described below.

The investment and financing amount, interbank loan amount, and capital buffer amount of each bank are described in a financial management table. The investment and financing amount of each investment and financing destination of each bank is recorded in an investment and financing management table. The sum of the investment and financing amounts of all investment and financing destinations is equal to the investment and financing amount of the financial management table. In an interbank loan management table, the interbank loan amount of each bank that is a borrower is recorded for each bank that is a lender. The sum of the interbank loan amounts of all banks that are borrowers is equal to the interbank loan amount of the financial management table. A structure including banks connected to each other by such interbank loans is referred to as a financial network.

First, an assumption is that one of investment and financing destinations fails. A bank suffers a loss of which an amount is equal to an investment and financing amount for this investment and financing destination. If a capital buffer amount is more than the amount of the loss, the bank does not go bankrupt. If all banks do not go bankrupt, the loss of the failure of the investment and financing destination is absorbed. In addition, the function of a financial network is maintained without change. If the capital buffer amount is less than the amount of the loss, the bank goes bankrupt.

An interbank loan made a borrower bank that becomes a bankrupt bank becomes irrecoverable. A bank that is a lender suffers the amount of the loss which is the amount of the interbank loan. If the capital buffer amount is more than an amount of a loss caused by a failure of an investment and financing destination and a bankruptcy of a borrower bank, the bank does not go bankrupt. If the capital buffer amount is smaller, the bank results in chain-reaction bankruptcies. A bank that is a lender making a loan to the bank that goes into the chain-reaction bankruptcies suffers he loss which is the amount of the interbank loan. Such a repetition causes the loss to propagate and the chain-reaction bankruptcies to spread out. When the chain no longer spreads out, the chain-reaction bankruptcies end. If the chain-reaction bankruptcies end, the number of banks that go bankrupt is totalized.

The scale of the number of chain-reaction bankruptcies in a case in which one of investment and financing destinations fail can be estimated by the models based on the technologies of NPL 1 to NPL 3. In other words, the magnitude of a systemic risk can be calculated.

### CITATION LIST

### Non Patent Literature

[NPL 1] E. Nier, J. Yang, T. Yorulmazer, A. Alentorn, Network models and financial stability, Journal of Economic Dynamics and Control vol. 31, pp. 2033-2060 (2007).

[NPL 2] A. G. Haldane, R. M. May, Systemic risk in banking ecosystems, Nature vol. 469, pp. 351-355 (2011).

[NPL 3] N. Beale, D. G. Rand, H. Battey, K. Croxson, R. M. May, M. A. Nowak, Individual versus systemic risk and the Regulator's Dilemma, Proceedings of the National Academy of Sciences USA vol. 108, pp. 12647-12652 (2011).

### SUMMARY OF INVENTION

### Technical Problem

The technologies of NPL 1 to NPL 3 enable a calculation of the magnitude of a current systemic risk to be calculated by estimation of the number of chain-reaction bankruptcies. However, the technologies of NPL 1 to NPL 3 are incapable of determining which bank has financial affairs to be improved in order to reduce a systemic risk. The technologies of NPL 1 to NPL 3 are also incapable of determining which bank has financial affairs to be improved in order to reduce a future systemic risk. In other words, the technologies of NPL 1 to NPL 3 are incapable of designating an important part with respect to a future systemic risk in a changeable financial network.

An object of the present invention is to provide a systemic risk management system capable of designating an important part with respect to a future systemic risk in a changeable financial network.

### Solution to Problem

A systemic risk management system according to one aspect of the present invention includes: sampling means for generating samples from a set of interbank loans, each of the interbank loans being a loan of a fund from any one of a plurality of banks to a borrower included in the plurality of banks, each of the samples being the set which is changed by a loan-conversion that is replacement of a borrower of an interbank loan selected form the set with a selected bank; important transaction designation means for selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the selected plurality of samples; and important bank designation means for designating an important bank based on the designated important interbank loan.

A systemic risk management method according to one aspect of the present invention includes: generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank; selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the selected plurality of samples; and designating an important bank based on the designated important interbank loan.

A storage medium according to one aspect of the present invention stores a systemic risk management program that causes a computer to execute: sampling processing of generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank; important transaction designation processing of selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the plurality of samples; and important bank designation processing that designates an important bank based on the designated important interbank loan. The present invention is also accomplished by a systemic risk management program stored in the storage medium described above.

### Advantageous Effects of Invention

The present invention has the effect of being capable of designating an important part in relation to a future systemic risk in a changeable financial network.

### BRIEF DESCRIPTION OF DRAWINGS

FIG. 1 is a block diagram illustrating an example of a configuration of systemic risk management systems of first, second, and third example embodiments of the present invention.

FIG. 2 is a view schematically illustrating an example of a bank financial management table of the first, the second, and the third example embodiments of the present invention.

FIG. 3 is a view schematically illustrating an example of an investment and financing management table of the first, the second, and the third example embodiments of the present invention.

FIG. 4 is a view schematically illustrating an example of an interbank loan management table of the first, the second, and the third example embodiments of the present invention.

FIG. 5 is a view schematically illustrating an example of a sample management table of the first, the second, and the third example embodiments of the present invention.

FIG. 6 is a view schematically illustrating an example of a chain-reaction bankruptcy number management table of the first example embodiment of the present invention.

FIG. 7 is a flowchart illustrating an example of the operations of systemic risk management devices of the first, the second, and the third example embodiments of the present invention.

FIG. 8 is a flowchart illustrating an example of the operations of the systemic risk management devices of the first, the second, and the third example embodiments of the present invention.

FIG. 9 is a view schematically illustrating an example of a chain-reaction bankruptcy number management table in the second and the third example embodiments of the present invention.

FIG. 10 is a block diagram illustrating an example of a configuration of a systemic risk management system of a fourth example embodiment of the present invention.

FIG. 11 is a view illustrating an example of a hardware configuration of a computer with which the systemic risk management devices according to the example embodiments of the present invention can be achieved.

FIG. 12 is a block diagram illustrating another example of a configuration of the systemic risk management system of the fourth example embodiment of the present invention.

FIG. 13 is a flowchart illustrating an example of an operation of the systemic risk management system of the fourth example embodiment of the present invention.

FIG. 14 is a block diagram illustrating an example of a configuration, implemented using a circuit, of the systemic risk management systems of the first, the second, and the third example embodiments of the present invention.

FIG. 15 is a block diagram illustrating an example of a configuration, implemented using a circuit, of the systemic risk management system of the fourth example embodiment of the present invention.

### DESCRIPTION OF EMBODIMENTS

A bank commonly makes investment and financing for supplying funds in the forms of financing and investment to a company and the like. Such a bank further makes an interbank loan for loaning funds to another bank. A financial network refers to, for example, a graph-like structure representing an interbank transaction relationship including an interbank loan of funds, as described above. When the data of the financial network is represented by a graph including nodes and an edge, a bank is represented by a node, and an interbank loan is represented by an edge. In the following description, a company or the like in which investment and financing are made by a bank is referred to as “investment and financing destination.” An invested fund and a financed fund may be referred to as “investment and financing.” An interbank loan of funds is also referred to as “interbank loan.” A fund loaned through an interbank loan may also be referred to as “interbank loan.” A bank that is a lender which loans funds in an interbank loan is also referred to as “lender.” A bank that is a borrower to which funds are loaned in an interbank loan is also referred to as “borrower.”

In the description of each example embodiment of the present invention, when an investment and financing destination fails, investment and financing in the investment and financing destination are irrecoverable. In other words, the loss of the investment and financing in the investment and financing destination is caused. Hereinafter, the loss of investment and financing in an investment and financing destination that fails is referred to as a direct loss due to the failure of the investment and financing destination. The bankruptcy of a bank making investment and financing due to the loss of the investment and financing caused by the failure of an investment and financing destination is referred to as “bankruptcy due to failure of investment and financing destination” or the like.

When a bank that is a borrower of an interbank loan goes bankrupt, the interbank loan to the bank is irrecoverable. In other words, the loss of the interbank loan to the borrower is caused. The bankruptcy of a bank making an interbank loan due to the loss of the interbank loan caused by the bankruptcy of a borrower is referred to as “bankruptcy due to bankruptcy of bank that is borrower” or the like.

A loss referred to as “indirect loss due to failure of investment and financing destination” in the following description includes a loss of an interbank loan to a borrower due to a bankruptcy of a bank that is the borrower due to a direct loss caused by the failure of an investment and financing destination. The indirect loss due to the failure of the investment and financing destination further includes the loss of the interbank loan to a borrower caused by the bankruptcy of the bank that is the borrower due to the indirect loss due to the failure of the investment and financing destination or due to the combination of the direct loss and the indirect loss. “Bankruptcy of bank due to influence of failure of investment and financing destination” represents a bankruptcy of a bank due to at least either a direct loss or an indirect loss due to the failure of an investment and financing destination. “Chain-reaction bankruptcy” represents the bankruptcy of a bank due to the influence of the failure of the investment and financing destination described above. “Chain-reaction bankruptcy number” represents the number of the bankruptcies of banks due to the influence of the failure of an investment and financing destination, i.e., the number of banks going bankrupt due to chain-reaction bankruptcies.

Example embodiments of the present invention will be described next in detail with reference to drawings.

### First Example Embodiment

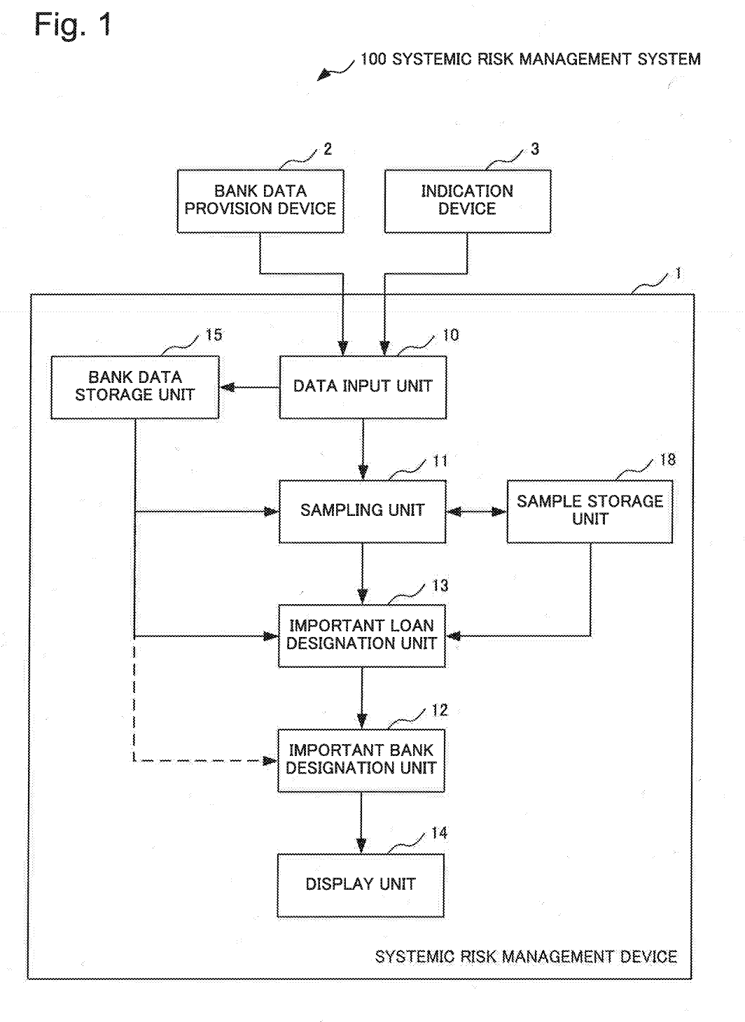

FIG. 1 is a block diagram illustrating an example of a configuration of a systemic risk management system 100 of a first example embodiment of the present invention. In FIG. 1 and other block diagrams described later, the directions of sending data are not limited to the directions of the drawn arrows. In the example illustrated in FIG. 1, the systemic risk management system 100 of the present example embodiment includes a systemic risk management device 1. The systemic risk management device 1 and the systemic risk management system 100 may be implemented as a single device such as the systemic risk management device 1 in the example illustrated in FIG. 1. The systemic risk management device 1 and the systemic risk management system 100 may be implemented as a plurality of devices which cooperatively operate, thereby performing the same operation as the operation of the systemic risk management device 1 implemented as a single device. When the systemic risk management device 1 and the systemic risk management system 100 are implemented as a plurality of devices, the plurality of devices may be connected communicably to each other through a communication network or the like. The communication network is achieved by at least either wired communication or wireless communication.

The systemic risk management system 100 further includes a bank data provision device 2 and an indication device 3. The systemic risk management device 1 is connected communicably to the bank data provision device 2 and the indication device 3 via a communication network or the like. The bank data provision device 2 and the indication device 3 may be implemented as the same device.

The systemic risk management device 1 includes a data input unit 10, a sampling unit 11, an important bank designation unit 12, an important loan designation unit 13, a display unit 14, a bank data storage unit 15, and a sample storage unit 18.

The bank data provision device 2 provides bank financial information, investment and financing information, and interbank loan information to the systemic risk management device 1. The bank financial information is information about the financial affairs of a plurality of banks. The bank financial information includes an amount of a capital buffer, which is a capital that can be used for absorbing a loss, of each of the plurality of banks. The investment and financing information is information about the investment and financing of the banks. The investment and financing information includes an amount of the investment and financing made by a bank in each investment and financing destination for each of the banks. The interbank loan information is information of an interbank loan which is a loan from a bank that is a lender to a bank that is a borrower. The interbank loan information includes the information of a bank (i.e., a lender) that loans funds, the information of a bank (i.e., a borrower) that borrows the funds from the bank, and the amount of the interbank loan, for each of the interbank loans. As described above, a financial network refers to a graph-like structure representing an interbank transaction relationship including an interbank loan. The financial network is represented by the interbank loan information. The bank financial information, the investment and financing information, and the interbank loan information are described in detail later.

Information provided to the systemic risk management device 1 by the bank data provision device 2 may be prepared by, for example, a administrator of the systemic risk management system 100 and stored in the bank data provision device 2 in advance. The information provided to the systemic risk management device 1 by the bank data provision device 2 may be information input into the bank data provision device 2 using, for example, an input device (not illustrated) such as a keyboard by, for example, the administrator of the systemic risk management system 100.

The indication device 3 sends information indicating an investment and financing destination that first fails (i.e., investment and financing destination ID (identification) of investment and financing destination that first fails) to the systemic risk management device 1. The investment and financing destination designated by the investment and financing destination ID sent to the systemic risk management device 1 is selected by, for example, the administrator of the systemic risk management system 100. The systemic risk management device 1 performs an operation described below on the assumption that the investment and financing destination of which the investment and financing destination ID is sent by the indication device 3 fails. In the following description, the investment and financing destination designated by the investment and financing destination ID sent to the systemic risk management device 1 is also referred to as “failed investment and financing destination.” The administrator of the systemic risk management system 100 or the like may select the failed investment and financing destination from investment and financing destinations in which investment and financing are made by at least any one of the banks included in the financial network described above. The indication device 3 may select the failed investment and financing destination, by a predetermined method, from investment and financing destinations in which investment and financing are made by at least any one of the banks included in the financial network described above.

The data input unit 10 acquires the bank financial information, the investment and financing information, and the interbank loan information from the bank data provision device 2. The data input unit 10 stores the received bank financial information, the investment and financing information, and the interbank loan information in the bank data storage unit 15. The data input unit 10 further receives the investment and financing destination ID from the indication device 3. The data input unit 10 sends the received investment and financing destination ID to the sampling unit 11.

The bank data storage unit 15 stores the bank financial information, the investment and financing information, and the interbank loan information.

The sampling unit 11 generates a predetermined number (hereinafter referred to as “predetermined sample number”) of samples, and stores the generated samples in the sample storage unit 18, for example, in such a manner as described below.

The sampling unit 11 selects a predetermined number (hereinafter referred to as “predetermined loan number”) of interbank loans from a plurality of interbank loans (i.e., set of interbank loans) represented by the interbank loan information stored in the bank data storage unit 15 by a predetermined method. As described above, the interbank loans included in the interbank loan information represent the financial network. The sampling unit 11 may randomly or approximately randomly select the predetermined sample number of interbank loans.

The sampling unit 11 specifies one interbank loan from the selected interbank loans. The sampling unit 11 selects a bank by a predetermined method. The sampling unit 11 may randomly or approximately randomly select the bank from a set of banks. The set of banks is, for example, a set of banks of which information about financial affairs is included in the bank financial information stored in the bank data storage unit 15. The sampling unit 11 changes a borrower of the specified interbank loan to the selected bank. In each of the example embodiments of the present invention, a change of a borrower of an interbank loan to another bank is referred to as “loan-conversion.” An interbank loan of which a borrower is changed is referred to as “interbank loan to which loan-conversion is performed.” The sampling unit 11 repeats a loan-conversion until loan-conversions for all of the predetermined loan number of selected interbank loans end.

The sampling unit 11 stores, as a sample, information representing a financial network including selected interbank loans to each of which loan-conversion is performed (i.e., information representing a set of interbank loans including selected interbank loans to each of which loan-conversion is performed) in the sample storage unit 18.

A sample represents a set of interbank loans resulting from a change of a set of interbank loans included in the bank financial information stored in the bank data storage unit 15 by loan-conversions. In other words, a sample represents a financial network changed by loan-conversions. The sample stored in the sample storage unit 18 by the sampling unit 11 need not be the data of the entire set of changed interbank loans. The sampling unit 11 may store data of changed part of a set of interbank loans changed by loan-conversions as a sample in the sample storage unit 18.

A sample is, for example, a combination including a bank ID of a bank that is a lender, a bank ID of a bank that is a borrower before loan-conversions, and a bank ID of a bank that is a borrower after the loan-conversions, of each of the selected interbank loans. The sampling unit 11 may assign an identifier (i.e., sample ID) to a sample, may associate the sample with the sample ID, and may store the sample associated with the sample ID in the sample storage unit 18.

The sampling unit 11 repeats generation of a sample and storage of the generated sample in the sample storage unit 18 until the predetermined sample number of samples are stored in the sample storage unit 18. The generation of the samples represents the selections of the predetermined loan number of interbank loans described above and the changes of the selected interbank loans by loan-conversions.

The sampling unit 11 further derives, for example, the scale of bankruptcies of a plurality of banks of which information about the financial affairs is stored as bank financial data in the bank data storage unit 15 due to the influence of the failure of a failed investment and financing destination. In such a case, the sampling unit 11 may derive the chain-reaction bankruptcy number of banks due to the influence of the failure of the failed investment and financing destination, and may further derive an index value representing the scale of bankruptcies of the plurality of banks as, for example, the scale of bankruptcies of the plurality of banks on the basis of the derived chain-reaction bankruptcy number, for example, in a manner described below.

The sampling unit 11 derives the chain-reaction bankruptcy number due to the influence of the failure of the failed investment and financing destination for each of the samples. The sampling unit 11 may derive the chain-reaction bankruptcy number for each of samples on the basis of the bank financial information, the bank investment and financing information, the interbank loan information, and the investment and financing destination ID of the failed investment and financing destination. The sampling unit 11 may use, for example, such a model as described in Background Art to derive the chain-reaction bankruptcy number. The sampling unit 11 determines whether a bank goes into bankruptcy by comparing the amount of a loss with the amount of the capital buffer of the bank, for example, in a manner described below. The sampling unit 11 considers, as the amount of the loss, the sum of the amount of investment and financing made in a failed investment and financing destination by the bank for which determination whether to go into bankruptcy is performed and the amount of the interbank loan by the bank to a bank that is a borrower determined to have already gone bankrupt.

For example, the sampling unit 11 first specifies banks making investment and financing in a failed investment and financing destination. The sampling unit 11 determines whether or not each of the specified banks goes bankrupt due to the loss of investment and financing in the failed investment and financing destination, caused by the failure of the failed investment and financing destination.

The sampling unit 11 further specifies a bank making an interbank loan to a bank determined to have gone bankrupt (i.e., a bank that is a lender of an interbank loan to a bank that is a borrower determined to have gone bankrupt). The sampling unit 11 determines whether or not the specified bank goes bankrupt on the basis of the losses of the investment and financing in the failed investment and financing destination and the interbank loan of the borrower that has gone bankrupt. The sampling unit 11 repeats the operation of specifying a bank making an interbank loan to a bank newly determined to have gone bankrupt and determining whether or not the specified bank goes bankrupt until any bank newly determined to have gone bankrupt becomes absent.

When any bank newly determined to have gone bankrupt becomes absent, the sampling unit 11 totals, as the chain-reaction bankruptcy number, the number of the banks determined to have gone bankrupt.

The bankruptcy of a bank due to at least either the failure of a failed investment and financing destination or the bankruptcy of a bank that is a borrower of an interbank loan is a chain-reaction bankruptcy. The end of the chain of losses (or chain-reaction bankruptcies) represents that any bank newly determined to have gone bankrupt becomes absent. The number of banks determined to have gone bankrupt when any bank newly determined to have gone bankrupt becomes absent (i.e., when the chain of losses ends) is the chain-reaction bankruptcy number.

The sampling unit 11 derives an index value based on the derived chain-reaction bankruptcy number as the scale of bankruptcies of the plurality of banks for each of the samples. The index value is, for example, the chain-reaction bankruptcy number. In such a case, the sampling unit 11 may consider the derived chain-reaction bankruptcy number as the index value. The index value may be another value representing the scale of bankruptcies of the plurality of banks. In the following description, the scale of bankruptcies of the plurality of banks is also simply referred to as “scale of bankruptcies.”

The sampling unit 11 stores the chain-reaction bankruptcy number derived for each of the samples, for example, in the sample storage unit 18. For each of the samples, the sampling unit 11 may store the chain-reaction bankruptcy number associated with a sample in the sample storage unit 18. In such a case, specifically, first, the sampling unit 11 may associate a sample ID and the chain-reaction bankruptcy number derived for a sample represented by the sample ID with each other for each of the samples. The sampling unit 11 may store the chain-reaction bankruptcy number associated with the sample ID in the sample storage unit 18.

If the scale of bankruptcies derived by the sampling unit 11 is not the chain-reaction bankruptcy number, the sampling unit 11 further stores the scale of bankruptcies of the plurality of banks derived for each of the samples, for example, in the sample storage unit 18. The sampling unit 11 may further store the scale of bankruptcies associated with a sample for each of the samples in the sample storage unit 18. In such a case, specifically, first, the sampling unit 11 may associate a sample ID and the chain-reaction bankruptcy number and the scale of bankruptcies (for example, the above-described index value) derived for a sample represented by the sample ID with each other for each of the samples. The sampling unit 11 may store the chain-reaction bankruptcy number and the scale of bankruptcies associated with the sample ID in the sample storage unit 18.

The sample storage unit 18 stores samples each of which represents a set of interbank transactions changed by the sampling unit 11. Information representing one or more samples is also referred to as “sample information.” The sample storage unit 18 further stores the chain-reaction bankruptcy number associated with the sample ID for each of the samples. If the scale of bankruptcies is not the chain-reaction bankruptcy number, the sample storage unit 18 stores the chain-reaction bankruptcy number and the scale of bankruptcies associated with the sample ID for each of the samples. Information representing the chain-reaction bankruptcy number associated with the sample ID for each of the samples is also referred to as “information about the chain-reaction bankruptcy number.” Information representing the scale of bankruptcies associated with the sample ID for each of the samples is also referred to as “bankruptcy scale information.”

In the following description of the present example embodiment, a case in which the sampling unit 11 derives the chain-reaction bankruptcy number as the scale of bankruptcies is described.

The important loan designation unit 13 selects a predetermined number (hereinafter referred to as “predetermined selection number”) of samples from samples generated by the sampling unit 11 on the basis of the scales of bankruptcies (for example, index values) associated with the samples. The important loan designation unit 13 selects the predetermined selection number of samples, for example, in decreasing order of the scale of bankruptcies.

The important loan designation unit 13 designates an important bank transaction on the basis of interbank loans which are included in the predetermined selection number of selected samples and to which loan-conversions are performed. A sample is a set of interbank loans changed by loan-conversions, as described above. The important loan designation unit 13 totals the numbers individually for the interbank loans, for example, in the interbank loans before performing loan-conversions of the interbank loans which are included in the predetermined selection number of selected samples and in which loan-conversions are performed. The important loan designation unit 13 designates an important interbank loan on the basis of the numbers totaled individually for the interbank loans. Specifically, the important loan designation unit 13 designates, as the important interbank loan, for example, an interbank loan of which the number is the largest in the numbers totaled individually for the interbank loans. In such a manner, the important loan designation unit 13 designates the important interbank loan in the interbank loans before performing loan-conversions, by which the interbank loans are changed into the interbank loans included in the predetermined selection number of the selected samples. The important loan designation unit 13 sends information (i.e., a loan ID) that designates the designated important interbank loan to the important bank designation unit 12. The loan ID may be the combination of the bank ID of a bank that is a lender and the bank ID of a bank that is a borrower. The loan ID may be an identifier which is assigned to each of the interbank loans and is not the combination of the bank ID of a bank that is a lender and the bank ID of a bank that is a borrower.

The important bank designation unit 12 designates an important bank on the basis of the designated important interbank loan. Specifically, the important bank designation unit 12 designates, as the important bank, for example, a bank that is a lender of the designated important interbank loan. The important bank designation unit 12 sends the loan ID of the important interbank loan and the identifier (i.e., the bank ID) of the important bank to the display unit 14.

The display unit 14 receives the bank ID of the important bank and information (i.e., the loan ID) designating the designated important interbank loan from the important bank designation unit 12. The display unit 14 displays the important bank represented by the received bank ID and the designated important interbank loan represented by the received loan ID on, for example, a display device or the like (not illustrated).

Data stored in the bank data storage unit 15 and the sample storage unit 18 may be stored, for example, in the form of a table. The data stored in the form of a table may be recorded as a table on, for example, a relational database. The data stored in the form of a table may be recorded as, for example, a file in text format.

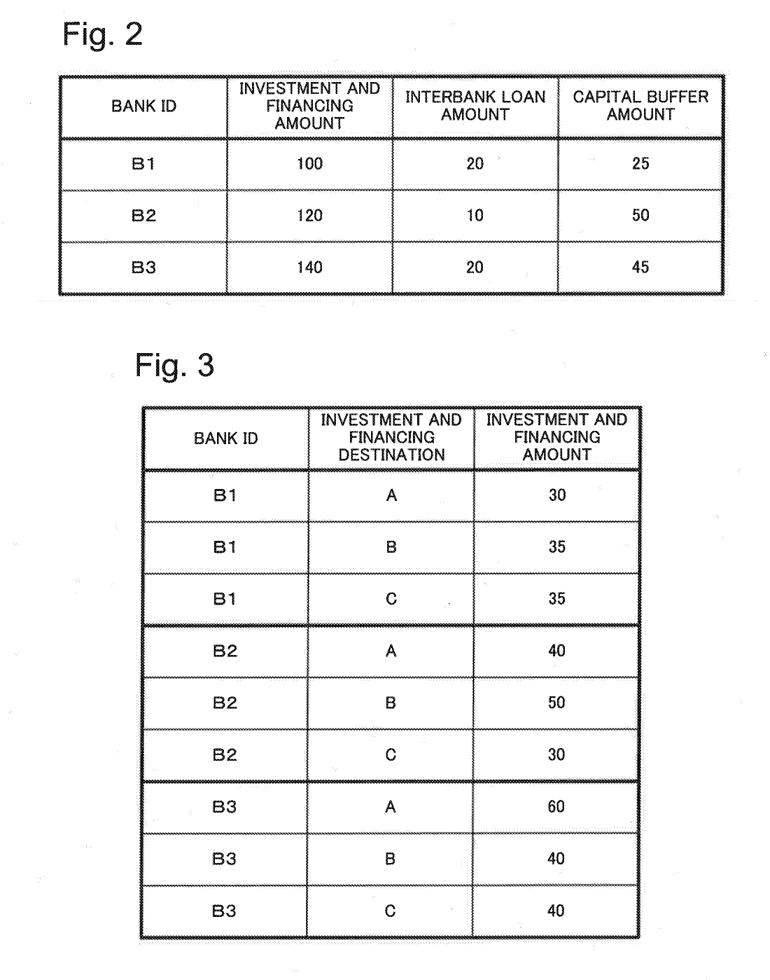

FIG. 2 is a view schematically illustrating an example of a bank financial management table. The bank financial management table includes an entry of a row for each of the banks. A value in each item of “BANK ID”, “INVESTMENT AND FINANCING AMOUNT”, “INTERBANK LOAN AMOUNT”, and “CAPITAL BUFFER AMOUNT” is recorded for each of the banks (i.e., for each of the rows). The investment and financing amount includes the amounts of all assets such as general loans and securities investments except the amount of a loan by an interbank loan. When an investment and financing destination fails, an asset price may become zero, whereby a bank may suffer a loss equivalent to an investment and financing amount. The interbank loan amount is the amount of a loan by an interbank loan. The capital buffer amount is the amount of a capital buffer representing a capital that need not be paid and can be immediately used for absorbing a loss. The capital buffer amount is ranked as a core equity capital in a narrow sense.

A bank ID which is an identifier that is capable of designating a bank individually and is assigned in advance to each of the banks is recorded in the item of “BANK ID.” The bank ID may be represented by a character string. The bank ID may be a code number that is assigned in advance to a bank and is unique to the bank. The bank ID may be a bank name, an abbreviated name unique to a bank, or the like. The total amount of the investment and financing held by a bank is recorded in the item of “INVESTMENT AND FINANCING AMOUNT.” The total amount of the interbank loans held by a bank is recorded in the item of “INTERBANK LOAN AMOUNT.” The amount of the capital buffer held by a bank is recorded in the item of “CAPITAL BUFFER AMOUNT.”

The investment and financing information stored in the bank data storage unit 15 may be stored as an investment and financing management table in the form of a table in the bank data storage unit 15. The investment and financing information is, for example, a combination of the bank ID, the investment and financing destination ID of the investment and financing destination, and the investment and financing amount in the investment and financing destination, of each of the banks included in the plurality of banks included in the financial network.

FIG. 3 is a view schematically illustrating an example of the investment and financing management table. Referring to FIG. 3, the investment and financing management table includes an entry of a row for each combination of a bank and an investment and financing destination. A value in each item of “BANK ID”, “INVESTMENT AND FINANCING DESTINATION”, and “INVESTMENT AND FINANCING AMOUNT” is recorded for each combination of a bank and an investment and financing destination. The bank ID of a bank making investment and financing is recorded in the item of “BANK ID.” The same bank IDs as the bank IDs used in the bank financial management table are used in the investment and financing management table and each table described below. An investment and financing destination ID which is an identifier that is capable of individually designating an investment and financing destination and is assigned in advance to each of the investment and financing destinations is recorded in the item of “INVESTMENT AND FINANCING DESTINATION.” The investment and financing destination ID may be a code symbol that is assigned to an investment and financing destination and is unique to the investment and financing destination. The investment and financing destination ID may be a name of a investment and financing destination, an abbreviated name unique to the investment and financing destination, or the like. An amount of investment and financing in an investment and financing destination held by a bank (i.e., an amount of funds invested and financed in the investment and financing destination by the bank) is recorded in the item of “INVESTMENT AND FINANCING AMOUNT.”

The interbank loan information stored in the bank data storage unit 15 may be stored as an interbank loan management table in the form of a table in the bank data storage unit 15. The interbank loan information is, for example, a combination of a bank ID, a bank ID of a bank that is a borrower of an interbank loan, and the amount of the interbank loan, of each of the banks included in the plurality of banks included in the financial network.

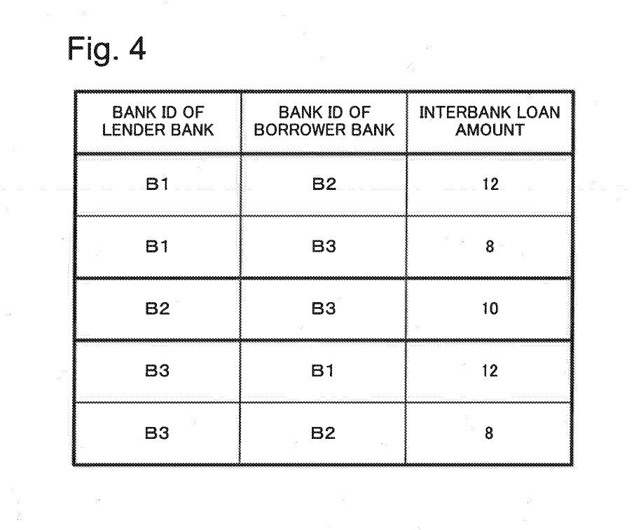

FIG. 4 is a view schematically illustrating an example of the interbank loan management table. Referring to FIG. 4, the interbank loan management table includes an entry of a row for each combination of a bank that is a lender and a bank that is a borrower. A value in each item of “bank ID of lender bank”, “BANK ID OF BORROWER BANK”, and “INTERBANK LOAN AMOUNT” is recorded for each combination of a bank that is a lender and a bank that is a borrower. The bank ID of a bank that is a lender of an interbank loan is recorded in the item of “BANK ID OF LENDER BANK.” The bank ID of a bank as a borrower of an interbank loan is recorded in the item of “BANK ID OF BORROWER BANK.” The same bank IDs as the bank IDs used in the bank financial management table and the investment and financing management table are also used in the interbank loan management table. The amount of an interbank loan which is a fund loaned to a bank that is a borrower by a bank that is a lender is recorded in “INVESTMENT AND FINANCING AMOUNT.”

The sample information stored in the sample storage unit 18 may be stored as a sample management table in the form of a table in the sample storage unit 18. The sample information is, for example, a combination of a sample ID, the bank ID of a bank that is a lender, the bank ID of a bank of that is a borrower before a loan-conversion, and the bank ID of a bank that is a borrower after a loan-conversion. The sample ID may be a number (hereinafter referred to as “sample number”) assigned uniquely to each sample. The sample management table in which such a sample ID is a sample number will be described below.

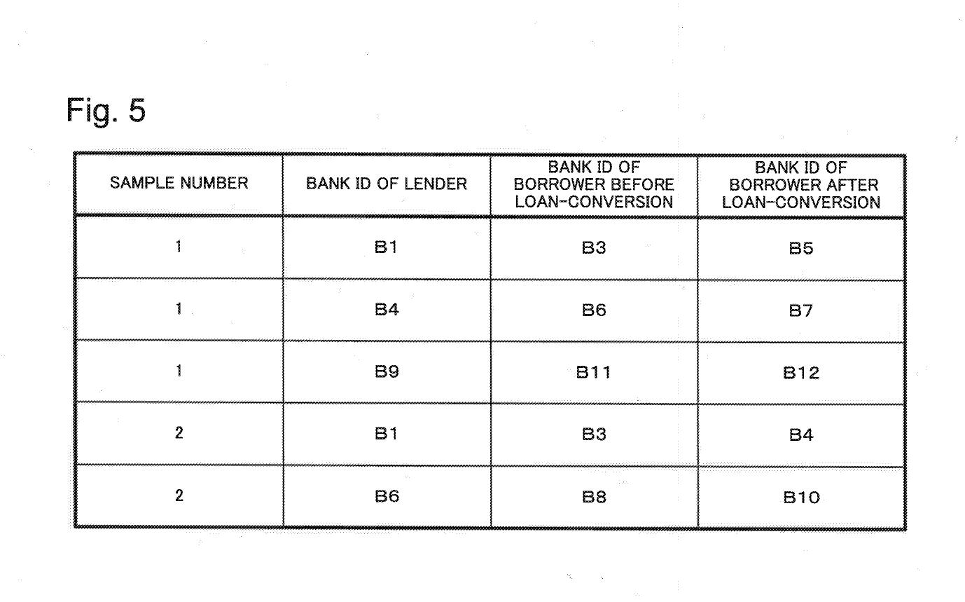

FIG. 5 is a view schematically illustrating an example of the sample management table. In the sample management table illustrated in FIG. 5, each row of the sample management table represents an interbank loan to which a loan-conversion is performed. Referring to FIG. 5, the sample management table includes an entry of a row for each of the interbank loans which are included in generated samples and to which loan-conversion is performed. A value in each item of “SAMPLE NUMBER”, “BANK ID OF LENDER”, “BANK ID OF BORROWER BEFORE LOAN-CONVERSION”, and “BANK ID of BORROWER after LOAN-CONVERSION” is recorded according to each interbank loan. In the example illustrated in FIG. 5, an integer value assigned in advance to a sample is recorded as an identifier (i.e., the sample ID described above) of the sample in “SAMPLE NUMBER.” The identifier (i.e., the bank ID) of a bank is recorded in “BANK ID OF LENDER”, “BANK ID of BORROWER BEFORE LOAN-CONVERSION”, and “BANK ID OF BORROWER AFTER LOAN-CONVERSION.” In the following description, a bank is represented by a character string including the bank ID of the bank. For example, a bank of which the bank ID is “BN” is referred to as “bank BN.”

In the example illustrated in FIG. 5, three rows for the sample of which the sample number is 1 are included in the sample management table. The sample management table illustrated in FIG. 5 represents that the sample of which the sample number is 1 is generated by three loan-conversions.

The first row of the sample management table illustrated in FIG. 5 represents that a borrower of an interbank loan of which a lender is a bank B1 and the borrower is a bank B3 is replaced with a bank B5. In other words, the first row represents that a loan-conversion which replaces the borrower with the bank B5 is performed in an interbank loan of which the lender is the bank B1 and the borrower is the bank B3. In further other words, the first row represents that the loan-conversion which converts the interbank loan from the bank B1 that is the lender to the bank B3 that is the borrower into the interbank loan from the bank B1 that is the lender to the bank B5 that is the borrower is performed. The second row of the sample management table illustrated in FIG. 5 represents that a loan-conversion which replaces a borrower with a bank B7 is performed in an interbank loan of which a lender is a bank B4 and the borrower is a bank B6. The third row of the sample management table illustrated in FIG. 5 represents that a loan-conversion which replaces a borrower with a bank B12 is performed in an interbank loan of which a lender is a bank B9 and the borrower is a bank B11.

The information about the chain-reaction bankruptcy number stored, for example, in the sample storage unit 18 may be stored as a chain-reaction bankruptcy number management table in the form a the table in the sample storage unit 18.

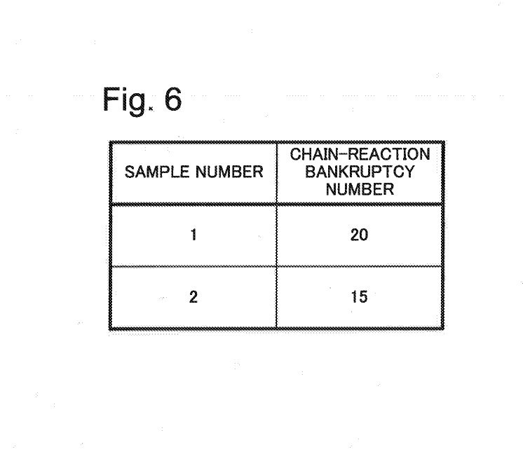

FIG. 6 is a view schematically illustrating an example of the chain-reaction bankruptcy number management table. Referring to FIG. 6, entries are made in a row according to each sample in which a rolled-over interbank loan is recorded in the sample management table in the chain-reaction bankruptcy number management table. A value in each item of “SAMPLE NUMBER” and “CHAIN-REACTION BANKRUPTCY NUMBER” is recorded for each of the samples. The sample numbers recorded as the values of the item of “SAMPLE NUMBER” are the same as the sample numbers used in the sample management table illustrated in FIG. 5. The number of banks determined to have gone into chain-reaction bankruptcies due to the influence of the failure of a failed investment and financing destination is recorded in “CHAIN-REACTION BANKRUPTCY NUMBER” for a sample represented by a sample number.

A case in which the systemic risk management device 1 deals with each table of information (for example, the bank financial information and the like), which is also recorded as tables described above, as the above-described tables (the bank financial management table in which bank financial information is recorded, and the like) in which the information is recorded in the form of a table is described below.

The operation of the systemic risk management device 1 of the present example embodiment will be described next in detail with reference to drawings.

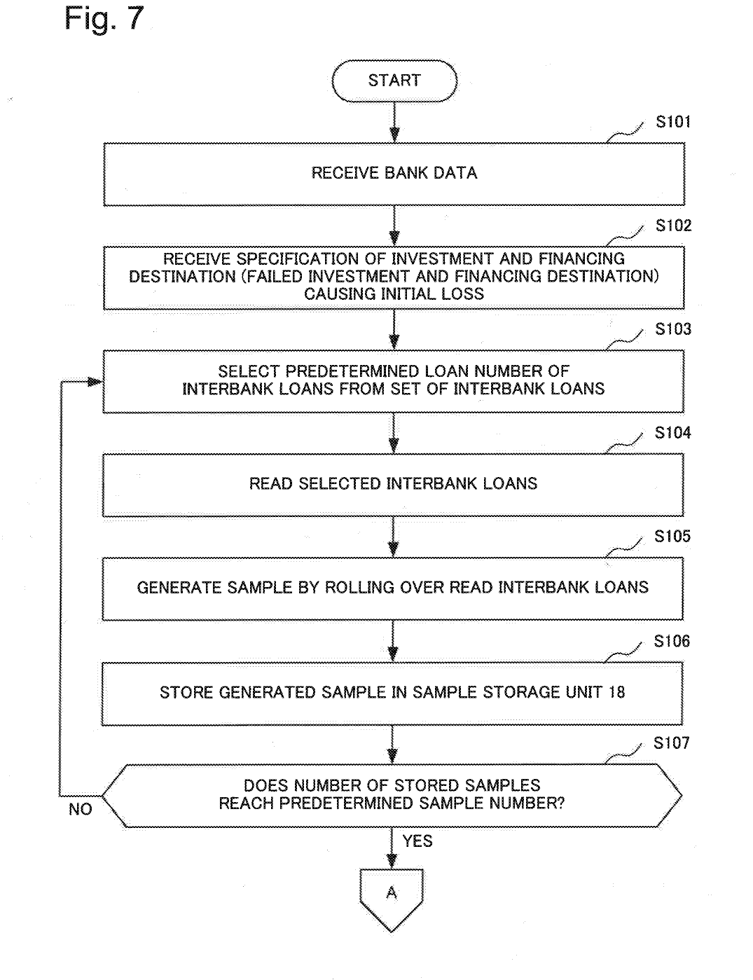

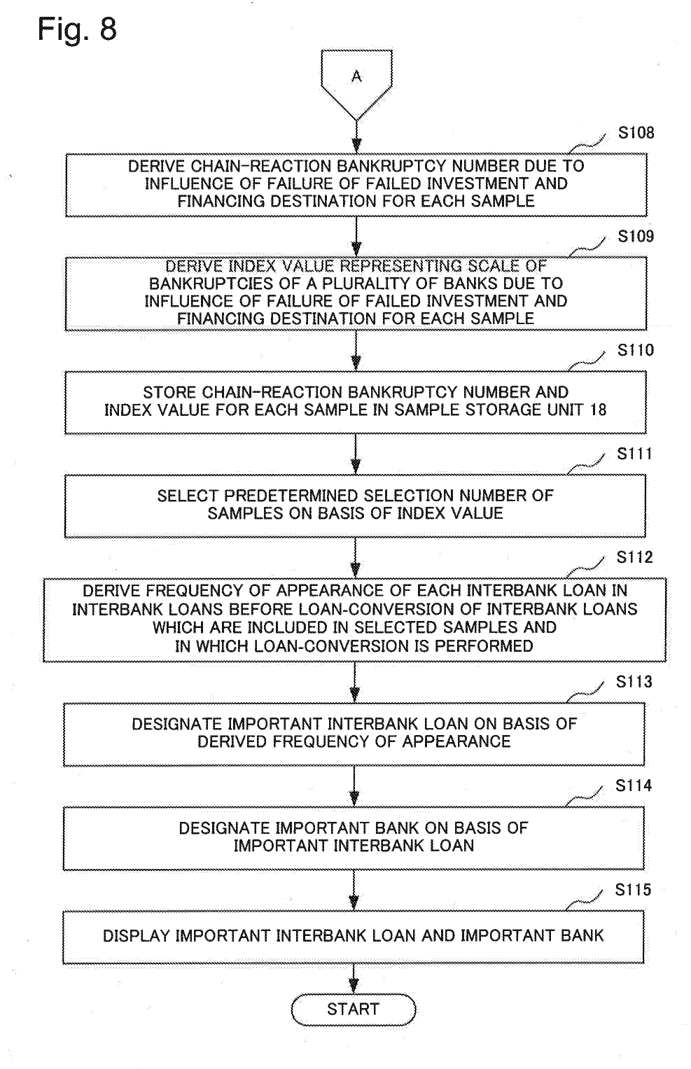

FIG. 7 and FIG. 8 are flowcharts representing an example of an operation of the systemic risk management device 1 of the present example embodiment.

Referring to FIG. 7, first, the data input unit 10 receives bank data from the bank data provision device 2 (step S101). The bank data is, for example, the bank financial management table, the investment and financing management table, and the interbank loan management table, described above. The data input unit 10 stores the received bank data in the bank data storage unit 15.

The data input unit 10 receives the identifier of an investment and financing destination that causes an initial loss (i.e., an investment and financing destination ID of a failed investment and financing destination) from the indication device 3 (step S102). The data input unit 10 sends the received investment and financing destination ID to the sampling unit 11.

The sampling unit 11 selects a predetermined loan number (for example, 500) of interbank loans from a set of interbank loans stored as the interbank loan management table in the bank data storage unit 15, for example, randomly (step S103). The sampling unit 11 reads the data of the selected interbank loans from the bank data storage unit 15 (step S104).

The sampling unit 11 generates a sample (step S105). In other words, the sampling unit 11 performs loan-conversions in the read interbank loans. In other words, the sampling unit 11 replaces a bank that is a borrower with another bank, thereby changing the borrower. As described above, the sample is a financial network changed by the loan-conversions. In other words, the sample is a sample of the financial network.

The sampling unit 11 specifies one interbank loan from the read interbank loans that is not specified yet. The sampling unit 11 selects one bank for the specified interbank loan from banks of which the information about the financial affairs is stored in the bank financial management table, for example, randomly. The sampling unit 11 replaces a borrower of the specified interbank loan with the selected bank. In other words, the sampling unit 11 performs a loan-conversion in the specified interbank loan. The sampling unit 11 repeats specification of an interbank loan and a loan-conversion in the specified interbank loan until all the read interbank loans are specified. If a borrower of a specified interbank loan is the same as a selected bank, the sampling unit 11 may select a bank again. The sampling unit 11 may replace a borrower regardless of whether or not the borrower of a specified interbank loan is the same as a selected bank.

The sampling unit 11 assigns a sample ID to the generated sample. The sample ID is a sample number assigned uniquely to each of the samples in the example illustrated in FIG. 5, as described above.

The sampling unit 11 stores the generated sample assigned with the sample ID in the sample storage unit 18 (step S106). In other words, the sampling unit 11 stores, as the sample, information representing the set of interbank loans after a loan-conversion in the sample storage unit 18. In other words, the sampling unit 11 records the generated sample in the sample management table.

The set of interbank loans after a loan-conversion can be designated by the information representing the loan-conversion and the set of interbank loans before the loan-conversion. In other words, the set of interbank loans after the loan-conversion is represented by the information representing the loan-conversion.

An interbank loan before a loan-conversion is designated by a bank ID of a bank that is a lender of the interbank loan in which the loan-conversion is performed and a bank ID of a bank that is a borrower before the loan-conversion of the interbank loan. An interbank loan after a loan-conversion is designated by a bank ID of a bank that is a lender of the interbank loan in which the loan-conversion is performed and a bank ID of a bank that is a borrower after the loan-conversion of the interbank loan. A loan-conversion that is performed is designated by a bank ID of a bank that is a borrower before the loan-conversion and a bank ID of a bank that is a borrower after the loan-conversion. Accordingly, information representing a loan-conversion is represented by a bank ID of a bank that is a lender, a bank ID of a bank that is a borrower before the loan-conversion, and a bank ID of a bank after the loan-conversion, of an interbank loan in which the loan-conversion is performed.

The sampling unit 11 records, for example, a sample number, a bank ID of a lender, a bank ID of a borrower before the loan-conversion, and a bank ID of a borrower after the loan-conversion as the information representing a set of interbank loans after the loan-conversion, i.e., as a generated sample in the sample management table.

When the number of samples stored in the sample storage unit 18 does not reach a predetermined sample number (for example, 1000) (NO in step S107), the sampling unit 11 repeats the operations of generation and storage of a sample after step S103. When the number of samples stored in the sample storage unit 18 reaches the predetermined sample number (for example, 1000) (YES in step S107), the sampling unit 11 then performs an operation of step S108 in FIG. 8.

Referring to FIG. 8, in step S108, the sampling unit 11 derives, for each of the samples, the chain-reaction bankruptcy number due to the influence of the failure of the failed investment and financing destination of which the investment and financing destination ID is received.

In addition, the sampling unit 11 derives an index value representing the scale of bankruptcies of the plurality of banks due to the influence of the failure of the failed investment and financing destination for each of the samples (step S109). In the present example embodiment, the index value representing the scale of bankruptcies is the chain-reaction bankruptcy number. Accordingly, the sampling unit 11 sets the chain-reaction bankruptcy number as the index value.

The sampling unit 11 stores the chain-reaction bankruptcy numbers and the derived index values individually for the samples, for example, in the sample storage unit 18 (step S110). As described above, in the present example embodiment, the derived index values are the chain-reaction bankruptcy numbers. When the index values are the chain-reaction bankruptcy numbers as in the present example embodiment, the sampling unit 11 may store the chain-reaction bankruptcy numbers individually for the samples in the sample storage unit 18. Accordingly, in the present example embodiment, the sampling unit 11 stores the chain-reaction bankruptcy numbers individually for the samples in the sample storage unit 18.

The sampling unit 11 may perform the operations from step S108 to step S110 before step S107 illustrated in FIG. 7. In other words, the sampling unit 11 may perform derivation of the chain-reaction bankruptcy number and the index value for a generated sample and storage of the derived chain-reaction bankruptcy number and the derived index value before generating the next sample.

Then, the important loan designation unit 13 selects a predetermined selection number (for example, 100) of samples on the basis of the index values (step S111). The important loan designation unit 13 may select the predetermined selection number of samples in deceasing order of the scale of bankruptcies on the basis of the index values. In the present example embodiment, the index values are the chain-reaction bankruptcy numbers. The important loan designation unit 13 may sort the samples on the basis of, for example, the magnitude of the chain-reaction bankruptcy numbers. For example, the important loan designation unit 13 may select, from the sorted samples, the predetermined selection number of samples in decreasing order of the chain-reaction bankruptcy number from the largest.

Then, the important loan designation unit 13 designates an important interbank loan on the basis of interbank loans which is included in the selected plurality of samples and to which loan-conversions are performed.

Specifically, the important loan designation unit 13 first totals the appearance number (i.e., a frequency of appearances) for each of the interbank loans in the interbank loans before performing loan-conversions of the interbank loans which are included in the selected plurality of samples and in which the loan conversions are performed (step S112).

The interbank loans before loan-conversions of the interbank loans in which loan-conversions are performed are the interbank loans selected as targets for loan-conversions in step S103. The important loan designation unit 13 specifies interbank loans selected as targets for loan-conversions for each of the selected samples. For each of the interbank loans, the important loan designation unit 13 totals, as the appearance number, the number of times an interbank loan is specified as an interbank loan selected as a target for a loan-conversion when any one of the selected samples is generated.

For example, in the example of the sample management table illustrated in FIG. 5, a sample IDs is associated with a bank ID of a lender of an interbank loans in which a loan-conversion is performed, a bank ID of a borrower before the loan-conversion, and a bank ID of a borrower after the loan-conversion. An interbank loan before a loan-conversion of an interbank loan in which the loan conversion is performed (i.e., an interbank loan selected in step S103) is specified by a bank ID of a lender and a bank ID of a borrower before the loan-conversion.

The important loan designation unit 13 may total the number of each combination of a bank ID of a lender and a bank ID of a borrower before a loan-conversion, which are associated with a sample ID of any one of selected samples, for example, in such a sample management table as shown in FIG. 5.

The important loan designation unit 13 designates an important interbank loan on the basis of the derived appearance numbers (i.e., frequencies of appearance as described above) (step S113). The important loan designation unit 13 may designate, for example, an interbank loan of which the appearance number derived in step S1212 is the largest as the important interbank loan.

The important loan designation unit 13 sends the loan ID of the designated important interbank loan (i.e., a combination of a bank ID of a lender and a bank ID of a borrower) to the important bank designation unit 12.

Then, the important bank designation unit 12 designates an important bank on the basis of the important interbank loan (step S114). The important bank designation unit 12 may designate, as the important bank, a bank that is a lender of the important interbank loan.

The important bank designation unit 12 sends the bank ID of the important bank and the information designating the important interbank loan to the display unit 14. The information designating the important interbank loan is, for example, a combination of the bank ID of the bank that is the lender of the important interbank loan (i.e., important bank) and the bank ID of the bank that is the borrower of the important interbank loan, as described above. Accordingly, in such a case, the important bank designation unit 12 may send the bank ID of the important bank and the bank ID of the bank that is the borrower of the important interbank loan to the display unit 14.

Then, the display unit 14 displays the important bank and the important interbank transaction (step S115). A display form in which the display unit 14 displays the important bank and the important interbank transaction may be any form in which the important bank and the important interbank transaction can be specified. The display form in which the display unit 14 displays the important bank and the important interbank transaction may be set by, for example, an administrator of the systemic risk management system 100. The display unit 14 may read the amount of the important interbank transaction from, for example, the bank data storage unit 15, and may further display the read amount of the interbank transaction.

### Operation Example Based on First Example Embodiment

As described above, the sample management table illustrated in FIG. 5 represents that the sample of which the sample number is 1 is generated by performing three loan-conversions. In addition, the sample management table illustrated in FIG. 5 represents that the sample of which the sample number is 2 is generated by performing two loan-conversions.

The first to third rows of the sample management table illustrated in FIG. 5 represent the three loan-conversions in the case of generating the sample of which the sample number is 1. As described above, the first row of the sample management table illustrated in FIG. 5 represents that a borrower of an interbank loan of which a lender is a bank B1 and the borrower is a bank B3 is replaced with a bank B5. In other words, the first row represents that a loan-conversion in which the borrower of the interbank loan of which the lender is the bank B1 and the borrower is the bank B3 is replaced with the bank B5 is performed. In further other words, the first row represents that the loan-conversion in which the interbank loan from the bank B1 that is the lender to the bank B3 that is the borrower is converted into the interbank loan from the bank B1 that is the lender to the bank B5 that is the borrower is performed. The second row of the sample management table illustrated in FIG. 5 represents that a loan-conversion in which a borrower of an interbank loan of which a lender is a bank B4 and the borrower is a bank B6 is replaced with a bank B7 is performed. The third row of the sample management table illustrated in FIG. 5 represents that a loan-conversion in which a borrower of an interbank loan of which a lender is a bank B9 and the borrower is a bank B11 is replaced with a bank B12 is performed.

The fourth and fifth rows of the sample management table illustrated in FIG. 5 represent the two loan-conversions in the case of generating the sample of which the sample number is 2. The fourth row of the sample management table illustrated in FIG. 5 represents that a loan-conversion in which a borrower of an interbank loan of which a lender is the bank B1 and the borrower is the bank B3 is replaced with the bank B4 is performed. The fifth row of the sample management table illustrated in FIG. 5 represents that a loan-conversion in which a borrower of an interbank loan of which a lender is the bank B6 and the borrower is a bank B8 is replaced with a bank B10 is performed.

The sampling unit 11 records the generated samples in, for example, the above-described sample management table as illustrated in FIG. 5.

In the example of the chain-reaction bankruptcy number management table illustrated in FIG. 6, the chain-reaction bankruptcy number due to the influence of the failure of a failed investment and financing destination, derived for the sample of which the sample number is 1, is 20. The chain-reaction bankruptcy number due to the influence of the failure of a failed investment and financing destination, derived for the sample of which the sample number is 12, is 15.

The sampling unit 11 records the derived chain-reaction bankruptcy numbers in, for example, the above-described chain-reaction bankruptcy number management table as illustrated in FIG. 6.

As described above, the important loan designation unit 13 selects a predetermined selection number of samples in decreasing order of the chain-reaction bankruptcy number from the largest. When the chain-reaction bankruptcy numbers recorded in the chain-reaction bankruptcy number management table illustrated in FIG. 6 are derived and the predetermined selection number is 2, the important loan designation unit 13 selects, in step S111, the sample of which the sample number is 1and the sample of which the sample number is 2.

In the example illustrated in FIG. 5, the most frequently appearing interbank loan before a loan-conversion is an interbank loan in which the bank ID of a lender is “B1” and the bank ID of a borrower before a loan-conversion is “B3.” Accordingly, the important loan designation unit 13 designates, as an important interbank loan, an interbank loan which is the interbank loan in which the bank ID of the lender is “B1” and the bank ID of the borrower before the loan-conversion is “B3”, i.e., an interbank loan from the bank B1 to the bank B3.

As described above, the bank ID of the lender of the designated important interbank loan is “B1.” Accordingly, the important bank designation unit 12 designates, as an important bank, a bank of which the bank ID is “B1”, i.e., the bank B1.

The example embodiment of the present invention has the first effect of being capable of designating an important part with respect to a future systemic risk in a changeable financial network.

The present example embodiment further has the second effect of being capable of easily managing the future systemic risk in the changeable financial network.

The reasons of the first and second effects are because the sampling unit 11 generates financial networks (i.e., samples of financial network) changed by changing borrowers of a predetermined number of selected interbank loans to banks selected, for example, randomly. In addition, the reason is because the sampling unit 11 derives the scale of bankruptcies of a plurality of banks due to the influence of the failure of a failed investment destination for each of a predetermined number of samples. Further, the reasons are because the important loan designation unit 13 designates an important interbank loan on the basis of the scale of bankruptcies derived for each of the predetermined number of samples. In addition, the important bank designation unit 12 designates an important bank on the basis of the designated important interbank loan.

The samples of the financial network in which borrowers of the predetermined number of interbank loans are changed can be considered as samples of the financial network changed in future. The scales of bankruptcies of a plurality of banks derived for such samples can be considered as the magnitude of a systemic risk changing in future. The important interbank loan designated based on the scales of bankruptcies of the plurality of banks derived for the plurality of samples can be considered as an interbank loan requiring the most significant improvement from the viewpoint of contribution to a reduction in systemic risk in future. In addition, the bank designated based on the designated important interbank loan can be considered as a bank requiring the most significant improvement from the viewpoint of contribution to a reduction in systemic risk in future.

Accordingly, the designated important interbank loan can be determined to be an important part with respect to a systemic risk in future in a changeable financial network. In addition, the important bank designated based on the designated important interbank loan can also be determined to be an important part with respect to a systemic risk in future in a changeable financial network.

As described above, an important bank and an important interbank loan made by the important bank, which are important parts with respect to a future systemic risk in a changeable financial network, can be designated in the present example embodiment. Accordingly, the systemic risk can be easily managed.

The effects of the present example embodiment can be expressed in other words as follows. The systemic risk management system 100 of the present example embodiment can designate the interbank loan with the highest importance among interbank loans from the viewpoint of contribution to a reduction in systemic risk in a future financial network at which a given financial network can irregularly change and arrive. In other words, the systemic risk management system 100 of the present example embodiment can designate the interbank loan requiring the most significant improvement. In addition, the systemic risk management system 100 of the present example embodiment can designate the bank with the highest importance among banks from the viewpoint of contribution to a reduction in systemic risk in a future financial network at which a given financial network can irregularly change and arrive. In other words, the systemic risk management system 100 of the present example embodiment can designate the bank requiring the most significant improvement.

### Second Example Embodiment

A second example embodiment of the present invention will be described next in detail with reference to the drawings.

FIG. 1 is a view illustrating a configuration of a systemic risk management system 100 of the present example embodiment. The configuration of the systemic risk management system 100 of the present example embodiment is the same as the configuration of the systemic risk management system 100 of the first example embodiment. The components of the present example embodiment are the same as the components of the first example embodiment, denoted by the same names, except differences described below. The operations of the present example embodiment are the same as the operations of the first example embodiment, denoted by the same reference characters, except differences described below.

In step S109 illustrated in FIG. 8, a sampling unit 11 of the present example embodiment derives, as an index value, an index value other than the chain-reaction bankruptcy number. The value derived as the index value by the sampling unit 11 is, for example, a large-asset bank bankruptcy ratio, a leading bank bankruptcy ratio, a bankruptcy growth rate, or the like. The large-asset bank bankruptcy ratio, the leading bank bankruptcy ratio, and the bankruptcy growth rate will be described in detail later. The sampling unit 11 further records the index value in a chain-reaction bankruptcy number management table.

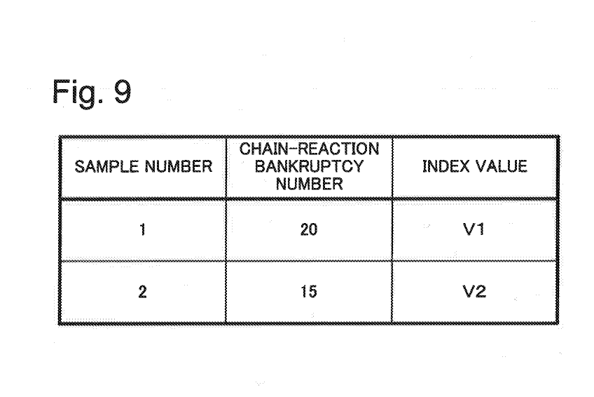

FIG. 9 is a view schematically illustrating an example of the chain-reaction bankruptcy number management table in the present example embodiment. In FIG. 9, a value in an item of which the item name is “INDEX VALUE” represents the derived index value.

The large-asset bank bankruptcy ratio, the leading bank bankruptcy ratio, and the bankruptcy growth rate will be described below.

The “large-asset bank bankruptcy ratio” represents the ratio of large-asset banks in banks that have gone bankrupt. In other words, the large-asset bank bankruptcy ratio is a value obtained by dividing the number of large-asset banks determined to have gone bankrupt before the propagation of losses ends by the chain-reaction bankruptcy number. A large-asset bank refers to a bank of which the total value of the investment and financing amount and the interbank loan amount is more than a predetermined asset threshold value. For example, in a case in which the asset threshold value is 150, the bank B3 corresponds to such a large-asset bank in the example of the bank financial management table illustrated in FIG. 2.

The “leading bank bankruptcy ratio” is the ratio of leading banks in banks that have gone bankrupt. In other words, the leading bank bankruptcy ratio is a value obtained by dividing the number of leading banks determined to have gone bankrupt before the propagation of losses ends by the chain-reaction bankruptcy number. A leading bank refers to a bank of which the rank of the total value of the investment and financing amount and the interbank loan amount in banks included in a financial network is equal to or higher than a rank indicated by a predetermined rank threshold value. In a case in which the rank threshold value is 2, the bank B2 and the bank B3 correspond to such leading banks in the example of the bank financial management table illustrated in FIG. 2.

The “bankruptcy growth rate” is the ratio of an initial bankruptcy number to a final chain-reaction bankruptcy number. The initial bankruptcy number is the number of bankruptcies just after one of investment and financing destinations has failed. The initial bankruptcy number is, for example, the number of banks determined to have gone bankrupt due to only the loss of investment and financing in a failed investment and financing destination. The final chain-reaction bankruptcy number is the number of final chain-reaction bankruptcies after the propagation of losses ends due to the failure of the investment and financing destination. The chain-reaction bankruptcy number illustrated in FIG. 9 is the final chain-reaction bankruptcy number. For example, in a case in which the initial bankruptcy number is 1 and the final chain-reaction bankruptcy number is 2, such a bankruptcy growth rate is 2 which is a value obtained by dividing 2 which is the final chain-reaction bankruptcy number by 1 which is the initial bankruptcy number.

The present example embodiment described above has the same effects as the effects of the first example embodiment. The reason thereof is the same as the reason why the effects of the first example embodiment are exhibited.

### Third Example Embodiment

A third example embodiment of the present invention will be described next in detail with reference to the drawings.

FIG. 1 is a view illustrating a configuration of a systemic risk management system 100 of the present example embodiment. The configuration of the systemic risk management system 100 of the present example embodiment is the same as the configuration of the systemic risk management system 100 of the second example embodiment. The components of the present example embodiment are the same as the components of the second example embodiment, denoted by the same names, except differences described below. The operations of the present example embodiment are the same as the operations of the second example embodiment, denoted by the same reference characters, except differences described below.

A data input unit 10 of the present example embodiment receives the kind of an index value from an indication device 3. For example, a user of the systemic risk management system 100 may designate the kind of the index value and the kind of the index value.

The kind of the index value indicates the chain-reaction bankruptcy number, a large-asset bank bankruptcy ratio, a leading bank bankruptcy ratio, or a bankruptcy growth rate. The data input unit 10 receives, as the kind of the index value, for example, a value indicating the chain-reaction bankruptcy number, a value indicating the large-asset bank bankruptcy ratio, a value indicating the leading bank bankruptcy ratio, or a value indicating the bankruptcy growth rate. Such values are set in advance and different from each other.

The data input unit 10 sends the received kind of the index value to a sampling unit 11.

In step S109 illustrated in FIG. 8, the sampling unit 11 of the present example embodiment derives, as an index value, an index value of which the kind is designated by the received kind of the index value. The value derived as the index value by the sampling unit 11 is, for example, a large-asset bank bankruptcy ratio, a leading bank bankruptcy ratio, a bankruptcy growth rate, or the like. When the received kind of the index value is the chain-reaction bankruptcy number, the sampling unit 11 may set the derived chain-reaction bankruptcy number as the index value.

The present example embodiment described above has the same effects as the effects of the first example embodiment. The reason thereof is the same as the reason why the effects of the first example embodiment are exhibited.

The present example embodiment further has the third effect of being capable of designating an important part with respect to a systemic risk from various viewpoints in a financial network.

The reason thereof is because the sampling unit 11 derives the index value of which the kind is designated by the received kind of the index value.

### Fourth Example Embodiment

A fourth example embodiment of the present invention will be described next in detail with reference to the drawings.

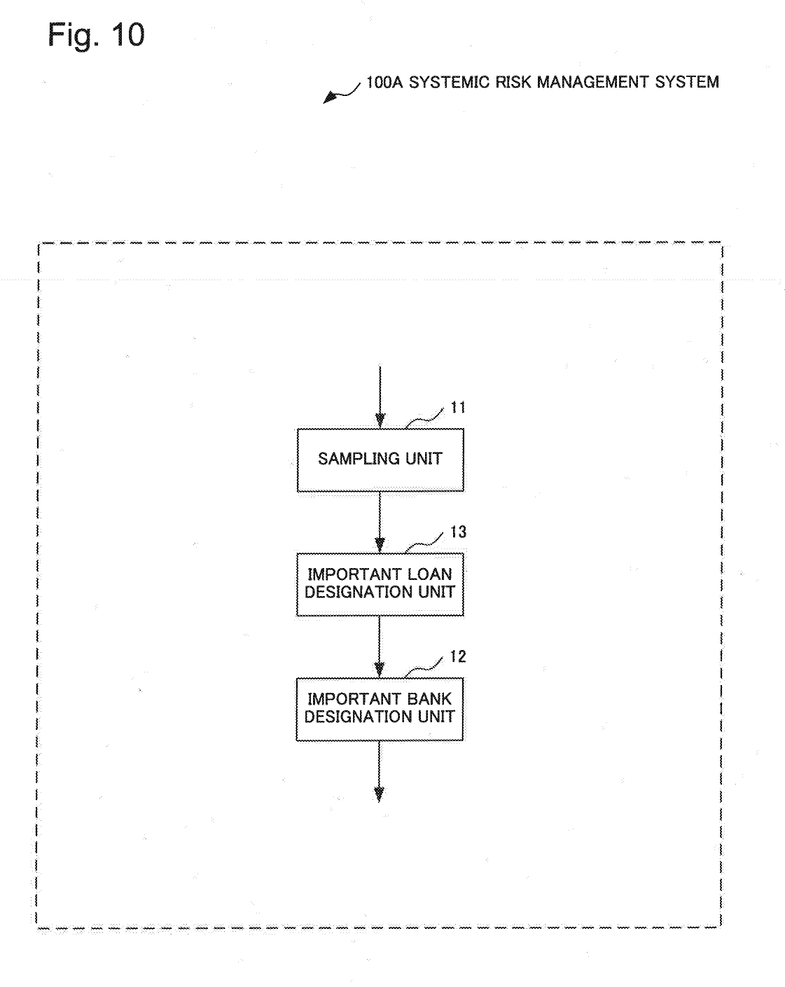

FIG. 10 is a block diagram illustrating an example of the configuring of a systemic risk management system 100A of the present example embodiment.

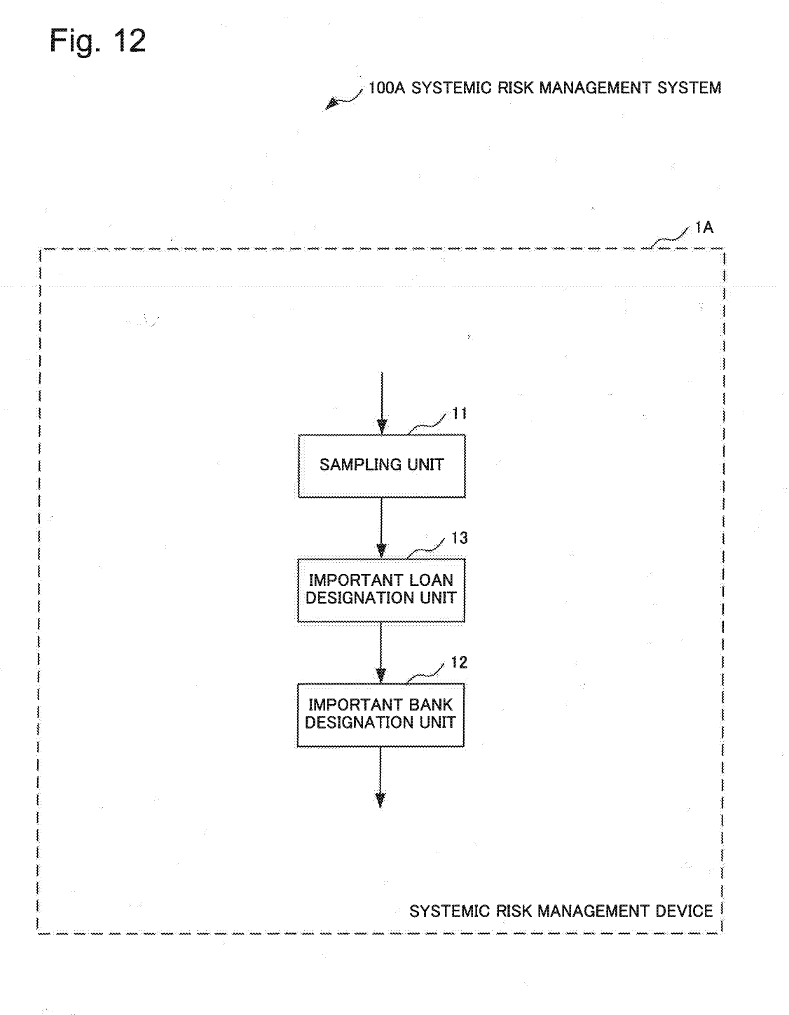

FIG. 12 is a block diagram illustrating another example of a configuring of the systemic risk management system 100A of the present example embodiment. For example, as illustrated in FIG. 132, the systemic risk management system 100A of the present example embodiment may be implemented as a systemic risk management device 1A which is one device. The systemic risk management system 100A may be implemented as a plurality of devices. When the systemic risk management system 100A is implemented as a plurality of devices, the plurality of devices may be communicably connected through a communication network and the like. The communication network is achieved by at least either wired communication or wireless communication. The systemic risk management system 100A of the present example embodiment may further include a bank data provision device (not illustrated) and an indication device (not illustrated) that are connected communicably with the systemic risk management device 1A through a communication network. The bank data provision device and indication device of the present example embodiment are the same as the bank data provision device 2 and indication device 3 of the first example embodiment, respectively.

The systemic risk management system 100A includes a sampling unit 11, an important loan designation unit 13, and an important bank designation unit 12. The sampling unit 11 generates samples each of which represents a set obtained by changing a set of interbank loans by a loan-conversion in which a borrower of interbank loan selected from the set is replaced with a selected bank. Such an interbank loan is a loan of funds from any one of a plurality of banks to a borrower included in the plurality of banks. The important loan designation unit 13 selects a plurality of samples from the generated samples on the basis of scales of bankruptcies of a plurality of banks, and designates an important interbank loan on the basis of interbank loans in each of which a loan-conversion is performed and which are included in the selected plurality of samples. Each of the scales of bankruptcies of the plurality of banks is a scale of bankruptcies of a plurality of banks due to the influence of the failure of a predetermined investment and financing destination in which investment and financing are made by at least any one of the plurality of banks. The scales of bankruptcies of the plurality of banks is derived for sets represented by the samples. The important bank designation unit 12 designates an important bank on the basis of the designated important interbank loan.

The operations of the systemic risk management system 100A of the present invention will be described nest in detail with reference to the drawings.

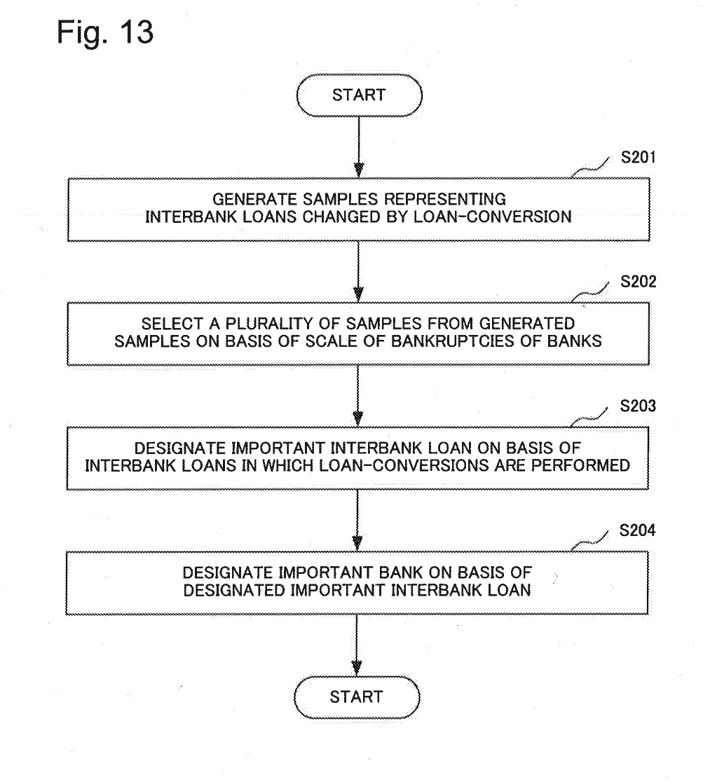

FIG. 13 is a flowchart illustrating an example of an operations of the systemic risk management system 100A of the present example embodiment.

Referring to FIG. 13, the sampling unit 11 generates samples each of which represents a changed set of interbank loans (step S201). The important loan designation unit 13 selects a plurality of samples from the generated samples on the basis of the scales of bankruptcies of banks (step S202). The important loan designation unit 13 designates an important interbank loan on the basis of interbank loans in which loan-conversions are performed (step S203). The important bank designation unit 12 designates an important bank on the basis of the designated important interbank loan (step S204).

The present example embodiment has the same effects as the effects of the first example embodiment. The reason thereof is the same as the reason why the effects of the first example embodiment are exhibited.

### Other Example Embodiment

Each of the systemic risk management devices according to the example embodiments of the present invention can be implemented with circuitry. The circuitry is a computer including, for example, a processor and a memory into which a program executed by the processor is loaded. The circuitry may be a plurality of computers that are communicably connected. The circuitry is, for example, a dedicated circuit. The circuitry may be a plurality of circuits that are connected communicably to each other. The circuitry may be a combination of one or more computers and one or more circuits that are communicably connected.

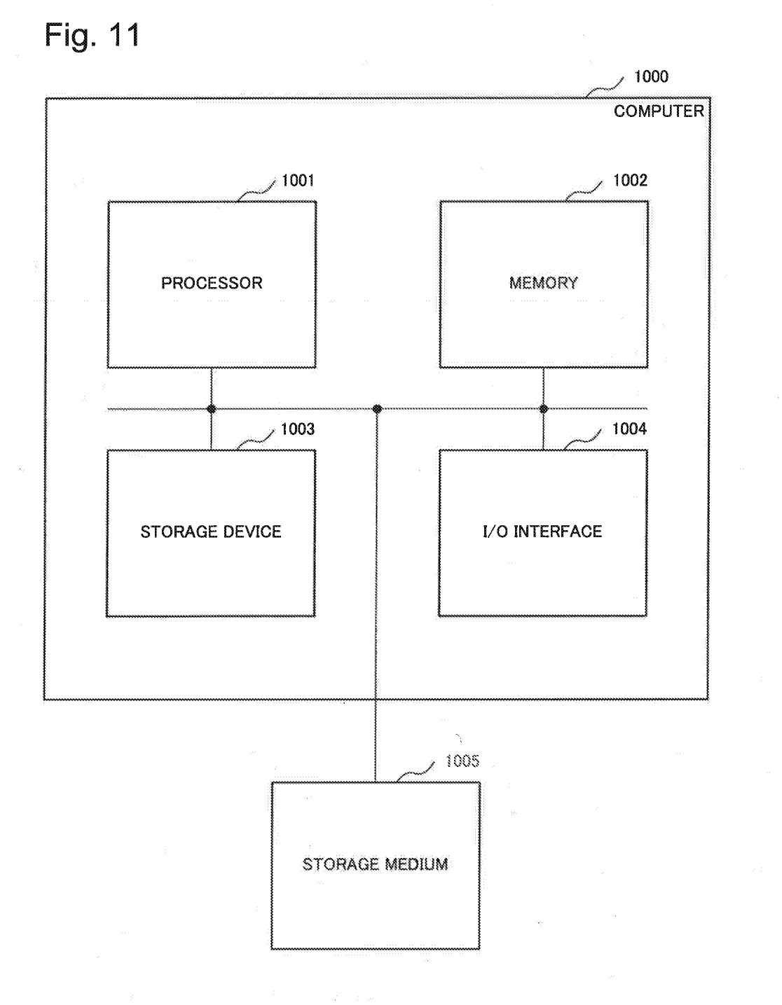

FIG. 11 is a view illustrating an example of the hardware configuration of a computer 1000 with which the systemic risk management devices 1 and 1A are able to be achieved. Referring to FIG. 11, the computer 1000 includes a processor 1001, a memory 1002, a storage device 1003, and an I/O (input/output) interface 1004. The computer 1000 can access a storage medium 1005. The memory 1002 and the storage device 1003 are, for example, storage devices such as a RAM (random access memory) and a hard disk. The storage medium 1005 is, for example, a storage device such as a RAM and a hard disk, a ROM (read only memory), or a removable storage medium. The storage device 1003 may be the storage medium 1005. The processor 1001 can read and write data and a program from/into the memory 1002 and the storage device 1003. The processor 1001 can communicate with, for example, the bank data provision device 2, the indication device 3, a display device (not illustrated), and the like via the I/O interface 1004. The processor 1001 can access the storage medium 1005. A program that causes the computer 1000 to operate as the systemic risk management device 1 or 1A is stored in the storage medium 1005.

The processor 1001 loads, into the memory 1002, the program that is stored in the storage medium 1005 and causes the computer 1000 to operate as the systemic risk management device 1 or 1A. The processor 1001 executes the program loaded into the memory 1002, thereby causing the computer 1000 to operate as the systemic risk management device 1 or 1A.

Each unit included in a first group described below can be achieved by, for example, a dedicated program that is loaded into the memory 1002 from the storage medium 1005 in which the program is stored and that can achieve the function of each unit, and by the processor 1001 which executes the program. The first group includes the data input unit 10, the sampling unit 11, the important loan designation unit 13, the important bank designation unit 12, and the display unit 14.

Each unit included in a second group described below can be achieved by the memory 1002 and the storage device 1003 such as a hard disk device which are included in the computer 1000. The second group includes the bank data storage unit 15 and the sample storage unit 18.

Alternatively, a part or all of the above-described units included in the first group and the above-described units included in the second group can also be achieved by a dedicated circuit that implements the function of each unit.

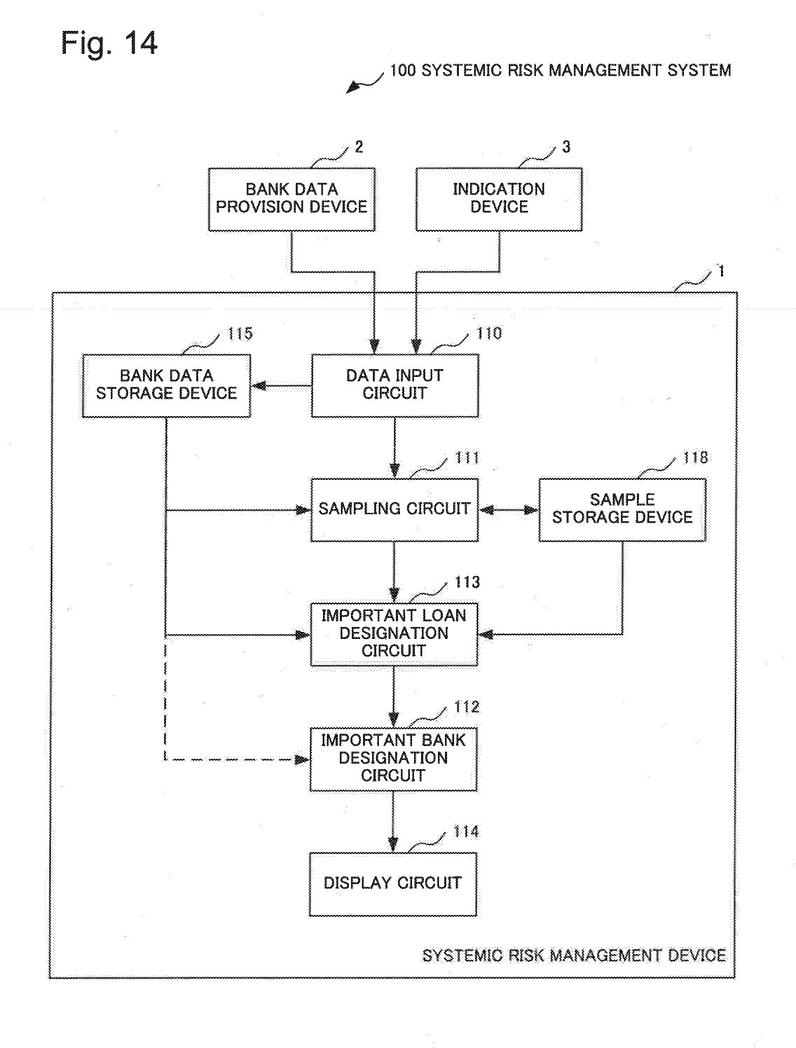

FIG. 14 is a block diagram illustrating an example of a configuration, implemented by using a dedicated circuit, of the systemic risk management devices 1 according to the first, second, and third example embodiments of the present invention. Referring to FIG. 14, the systemic risk management device 1 includes a data input circuit 110, a sampling circuit 111, an important bank designation circuit 112, an important loan designation circuit 113, a display circuit 114, a bank data storage device 115, and a sample storage device 118.

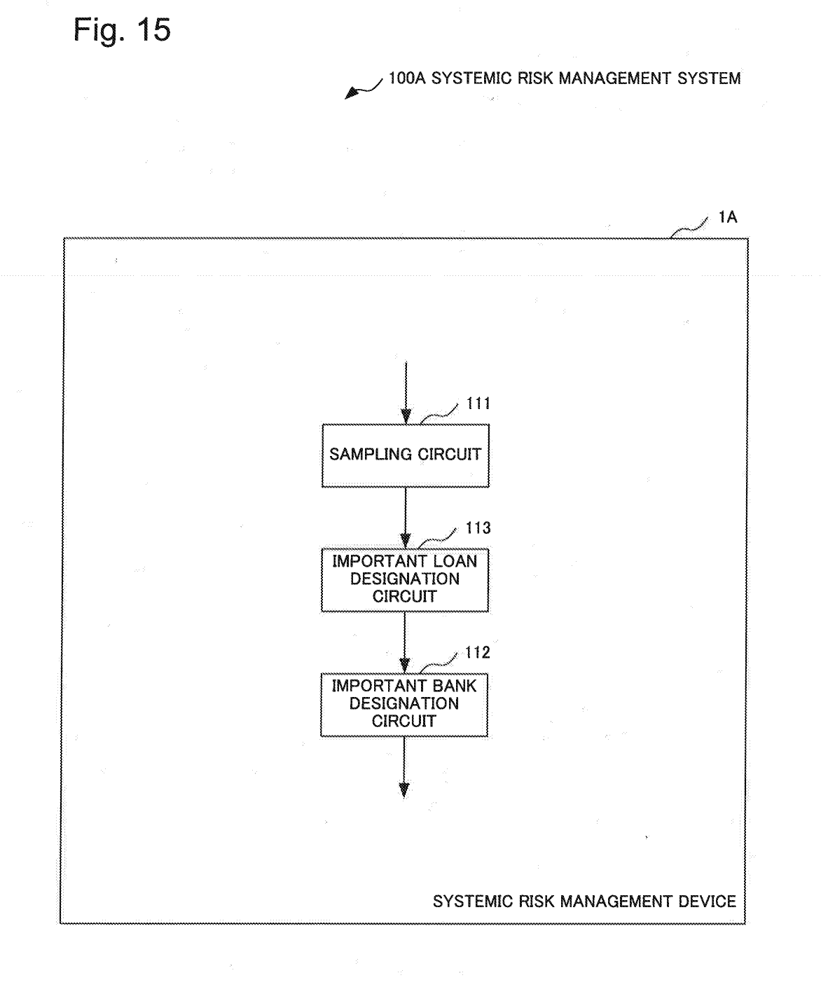

FIG. 15 is a block diagram illustrating an example of a configuration, implemented by using a dedicated circuit, of the systemic risk management device 1A according to the fourth example embodiment of the present invention. Referring to FIG. 15, the systemic risk management device 1A includes a sampling circuit 111, an important bank designation circuit 112, and an important loan designation circuit 113.

The data input unit 10 is achieved by the data input circuit 110. The data input circuit 110 operates as the data input unit 10. The sampling unit 11 is achieved by the sampling circuit 111. The sampling circuit 111 operates as the sampling unit 11. The important bank designation unit 12 is achieved by the important bank designation circuit 112. The important bank designation circuit 112 operates as the important bank designation unit 12. The important loan designation unit 13 is achieved by the important loan designation circuit 113. The important loan designation circuit 113 operates as the important loan designation unit 13. The display unit 14 is achieved by the display circuit 114. The display circuit 114 operates as the display unit 14. The bank data storage unit 15 is achieved by the bank data storage device 115. The bank data storage device 115 operates as the bank data storage unit 15. The sample storage unit 18 is achieved by the sample storage device 118. The sample storage device 118 operates as the sample storage unit 18.

A part or all of the example embodiments described above can also be described as in the following Supplementary Notes but are not limited thereto.

### Supplementary Note 1

A systemic risk management system including: sampling means for generating samples from a set of interbank loans, each of the interbank loans being a loan of a fund from any one of a plurality of banks to a borrower included in the plurality of banks, each of the samples being the set which is changed by a loan-conversion that is replacement of a borrower of an interbank loan selected form the set with a selected bank;

important transaction designation means for selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the selected plurality of samples; and

important bank designation means for designating an important bank based on the designated important interbank loan.

### Supplementary Note 2

The systemic risk management system according to Supplementary Note 1, wherein

the important transaction designation means totals appearance numbers individually for the interbank loans in the interbank loans before performing the loan-conversion of the interbank loans which are included in the selected plurality of samples and in which the loan-conversion is performed, and designates the important interbank loan in the interbank loans before the loan-conversion based on the totaled appearance numbers.

### Supplementary Note 3

The systemic risk management system according to Supplementary Note 2, wherein

the important transaction designation means designates, as the important interbank loan, the interbank loan of which the totaled appearance number is the largest.

### Supplementary Note 4

The systemic risk management system according to any one of Supplementary Notes 1 to 3, wherein

the important bank designation means derives the scale of bankruptcies based on bank financial data, investment and financing data and investment and financing data of the plurality of banks, the bank financial data including an amount of a capital buffer which is a capital capable of being used for absorbing a loss, the investment and financing data including an investment and financing amount for each investment and financing destination, the interbank loan data including an amount of an interbank loan for each bank that is a borrower.

### Supplementary Note 5

The systemic risk management system according to any one of Supplementary Notes 1 to 4, wherein

the important transaction designation means calculates an index value representing the scale of bankruptcies of the plurality of banks due to influence of the failure of the predetermined investment and financing destination, the scale being calculated for each of the samples, and selects a plurality of samples from the generated samples in decreasing order of the scale of bankruptcies, the scale being represented by the index value.

### Supplementary Note 6

The systemic risk management system according to Supplementary Note 5, wherein

the index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio which is a rate of a leading bank in the banks going bankrupt, the leading bank being a bank of which a rank of magnitude of the total value is not less than a predetermined rank; and

a bankruptcy growth rate which is a rate of a count of banks going bankrupt due to a loss of interbank loan made to another bank going bankrupt due to the failure to a count of banks going bankrupt due to a loss of investment and financing caused by the failure among the plurality of banks.

### Supplementary Note 7

The systemic risk management system according to any one of Supplementary Notes 1 to 6, wherein

the important bank designation means designates, as the important bank, the bank that is a lender of the designated important interbank loan.

### Supplementary Note 8

A systemic risk management method including:

generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank;

selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples;

designating an important interbank loan based on the interbank loans to which the loan-conversion is performed and which are included in the selected plurality of samples; and

designating an important bank based on the designated important interbank loan.

### Supplementary Note 9

The systemic risk management method according to Supplementary Note 8, the method further including:

totaling appearance numbers of the interbank loans with respect to the interbank loans before the loan-conversion in the interbank loans changed by the loan-conversion and included in the selected plurality of samples, and designating the important interbank loan in the interbank loans before the loan conversion based on the totaled appearance number.

### Supplementary Note 10

The systemic risk management method according to Supplementary Note 9, further including:

designating, as the important interbank loan, the interbank loan of which the totaled appearance number is the largest.

### Supplementary Note 11

The systemic risk management method according to any one of Supplementary Notes 8 to 10, further including:

deriving the scale of bankruptcies based on bank financial data, investment and financing data and investment and financing data of the plurality of banks, the bank financial data including an amount of a capital buffer which is a capital capable of being used for absorbing a loss, the investment and financing data including an investment and financing amount for each investment and financing destination, the interbank loan data including an amount of an interbank loan for each bank that is a borrower.

### Supplementary Note 12

The systemic risk management method according to any one of Supplementary Notes 8 to 11, further including:

calculating an index value representing the scale of bankruptcies of the plurality of banks due to influence of the failure of the predetermined investment and financing destination, the scale being calculated for each of the samples, and selecting a plurality of samples from the generated samples in decreasing order of the scale of bankruptcies, the scale being represented by the index value.

### Supplementary Note 13

The systemic risk management method according to Supplementary Note 12, wherein

the index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio which is a rate of a leading bank in the banks going bankrupt, the leading bank being a bank of which a rank of magnitude of the total value is not less than a predetermined rank; and

a bankruptcy growth rate which is a rate of a count of banks going bankrupt due to a loss of interbank loan made to another bank going bankrupt due to the failure to a count of banks going bankrupt due to a loss of investment and financing caused by the failure among the plurality of banks.

### Supplementary Note 14

The systemic risk management method according to any one of Supplementary Notes 8 to 13, further including:

designating, as the important bank, the bank that is a lender of the designated important interbank loan.

### Supplementary Note 15

A systemic risk management program that causes a computer to execute:

sampling processing of generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank;

important transaction designation processing of selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the plurality of samples; and

important bank designation processing that designates an important bank based on the designated important interbank loan.

### Supplementary Note 16

The systemic risk management program according to Supplementary Note 15, wherein

the important transaction designation processing totals appearance numbers individually for the interbank loans in the interbank loans before performing the loan-conversion of the interbank loans which are included in the selected plurality of samples and in which the loan-conversion is performed, and designates the important interbank loan in the interbank loans before the loan-conversion based on the totaled appearance numbers.

### Supplementary Note 17

The systemic risk management program according to Supplementary Note 16, wherein

the important transaction designation processing designates, as the important interbank loan, the interbank loan of which the totaled appearance number is the largest.

### Supplementary Note 18

The systemic risk management program according to any one of Supplementary Notes 15 to 17, wherein

the important bank designation processing derives the scale of bankruptcies based on bank financial data, investment and financing data and investment and financing data of the plurality of banks, the bank financial data including an amount of a capital buffer which is a capital capable of being used for absorbing a loss, the investment and financing data including an investment and financing amount for each investment and financing destination, the interbank loan data including an amount of an interbank loan for each bank that is a borrower.

### Supplementary Note 19

The systemic risk management program according to any one of Supplementary Notes 15 to 18, wherein

the important transaction designation processing calculates an index value representing the scale of bankruptcies of the plurality of banks due to influence of the failure of the predetermined investment and financing destination, the scale being calculated for each of the samples, and selects a plurality of samples from the generated samples in decreasing order of the scale of bankruptcies, the scale being represented by the index value.

### Supplementary Note 20

The systemic risk management program according to Supplementary Note 19, wherein

the index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio which is a rate of a leading bank in the banks going bankrupt, the leading bank being a bank of which a rank of magnitude of the total value is not less than a predetermined rank; and

a bankruptcy growth rate which is a rate of a count of banks going bankrupt due to a loss of interbank loan made to another bank going bankrupt due to the failure to a count of banks going bankrupt due to a loss of investment and financing caused by the failure among the plurality of banks.

### Supplementary Note 21

The systemic risk management program according to any one of Supplementary Notes 15 to 20, wherein

the important bank designation processing designates, as the important bank, the bank that is a lender of the designated important interbank loan.

### Supplementary Note 22

A storage medium storing the systemic risk management program according to any one of Supplementary Notes 15 to 20.

The present invention has been described above with reference to the example embodiments. However, the present invention is not limited to the example embodiments described above. Various modifications that can be understood by those skilled in the art in the scope of the present invention can be made in the constitution and details of the present invention.

This application claims priority based on Japanese Patent Application No. 2015-033997, which was filed on Feb. 24, 2015, and the entire disclosure thereof is incorporated herein.

### INDUSTRIAL APPLICABILITY

The present invention can be applied to applications in which an important bank requiring the most significant improvement under present circumstances and an important interbank loan in which the important bank is involved and which requires the most significant improvement are designated in order to reduce a systemic risk. The present invention can be applied to applications in which management of a systemic risk is facilitated in a financial network. The financial network means, for example, a graph-like structure representing an interbank transaction relationship including an interbank loan of funds, as described above. The systemic risk refers to, for example, the risk of collapse of the entire financial network rather than the risk of the bankruptcy of an individual bank. In other words, the systemic risk refers to, for example, the risk of occurrence of very serious chain-reaction bankruptcies.

### REFERENCE SIGNS LIST

1 Systemic risk management device

1A Systemic risk management device

2 Bank data provision device

3 Indication device

10 Data input unit

11 Sampling unit

12 Important bank designation unit

13 Important loan designation unit

14 Display unit

15 Bank data storage unit

18 Sample storage unit

100 Systemic risk management system

100A Systemic risk management system

110 Data input circuit

111 Sampling circuit

112 Important bank designation circuit

113 Important loan designation circuit

114 Display circuit

115 Bank data storage device

118 Sample storage device

1000 Computer

1001 Processor

1002 Memory

1003 Storage device

1004 I/O interface

1005 Storage medium

What is claimed is:

1. A systemic risk management system comprising:
a memory that stores a set of instructions; and
at least one first processor configured to execute the set of instructions to:
generate from a set of interbank loans, each of the interbank loans being a loan of a fund from any one of a plurality of banks to a borrower included in the plurality of banks, each of the samples being the set which is changed by a loan-conversion that is replacement of a borrower of an interbank loan selected form the set with a selected bank;
select a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designate an important interbank loan based on the interbank loans to which the loan-conversion is performed and which are included in the selected plurality of samples; and
designate an important bank based on the designated important interbank loan.

2. The systemic risk management system according to claim 1, wherein
the at least one first processor is further configured to:
total appearance numbers individually for the interbank loans in the interbank loans before performing the loan-conversion of the interbank loans which are included in the selected plurality of samples and in which the loan-conversion is performed, and designate the important interbank loan in the interbank loans before the loan-conversion based on the totaled appearance numbers.

3. The systemic risk management system according to claim 2, wherein
the at least one first processor is further configured to:
designate, as the important interbank loan, the interbank loan of which the totaled appearance number is the largest.

4. The systemic risk management system according to claim 1, wherein
the at least one first processor is further configured to:
derive the scale of bankruptcies based on bank financial data, investment and financing data and investment and financing data of the plurality of banks, the bank financial data including an amount of a capital buffer which is a capital capable of being used for absorbing a loss, the investment and financing data including an investment and financing amount for each investment and financing destination, the interbank loan data including an amount of an interbank loan for each bank that is a borrower.

5. The systemic risk management system according to claim 1, wherein
the at least one first processor is further configured to:
calculate an index value representing the scale of bankruptcies of the plurality of banks due to influence of the failure of the predetermined investment and financing destination, the scale being calculated for each of the samples, and select a plurality of samples from the generated samples in decreasing order of the scale of bankruptcies, the scale being represented by the index value.

6. The systemic risk management system according to claim 5, wherein
the index value is any one of:
a chain-reaction bankruptcy number which is a count of banks going bankrupt due to the failure among the plurality of banks;
a large-asset bank bankruptcy ratio which is a rate of a large-capital bank in the banks going bankrupt, the large-capital bank being a bank of which a total value of an investment and financing amount and an interbank loan amount is more than a predetermined value;
a leading bank bankruptcy ratio which is a rate of a leading bank in the banks going bankrupt, the leading bank being a bank of which a rank of magnitude of the total value is not less than a predetermined rank; and
a bankruptcy growth rate which is a rate of a count of banks going bankrupt due to a loss of interbank loan made to another bank going bankrupt due to the failure to a count of banks going bankrupt due to a loss of investment and financing caused by the failure among the plurality of banks.

7. The systemic risk management system according to claim 1, wherein
the at least one first processor is further configured to:
designate, as the important bank, the bank that is a lender of the designated important interbank loan.

8. A systemic risk management method comprising:
generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank;
selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the selected plurality of samples; and
designating an important bank based on the designated important interbank loan.

9. The systemic risk management method according to claim 8, the method further comprising:
totaling appearance numbers of the interbank loans with respect to the interbank loans before the loan-conversion in the interbank loans changed by the loan-conversion and included in the selected plurality of samples, and designating the important interbank loan in the interbank loans before the loan conversion based on the totaled appearance number.

10. A non-transitory computer readable storage medium storing a systemic risk management program that causes a computer to execute:
sampling processing of generating samples from a set of interbank loans, each of the interbank loans being a loan of a fund from any one of a plurality of banks to a borrower included in the plurality of banks, each of the samples being the set which is changed by loan-conversion that is replacement of a borrower of an interbank loan selected form the set with a selected bank;
important transaction designation processing of selecting a plurality of samples from the generated samples based on a scale of bankruptcies of the plurality of banks due to an influence of a failure of a predetermined investment and financing destination in which investment and financing are made by at least any one of the plurality of banks, the scale being derived for each set represented by the samples, and designating an important interbank loan based on the interbank loans to which the loan-conversion is performed and which are included in the plurality of samples; and
important bank designation processing that designates an important bank based on the designated important interbank loan.
